(19) United States
(12) Patent Application Publication
(10) Pub. No.: US 2010/0332590 A1
(43) Pub. Date: Dec. 30, 2010

(54) Inheritance communication administrating apparatus

(75) Inventors: Yu Minakuchi, Kawasaki (JP); Kinji Kawaguchi, Kawasaki (JP); Tomotaka Endo, Kawasaki (JP); Masahiko Ohashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/801,696

(22) Filed: Jun. 21, 2010

(30) Foreign Application Priority Data
Jun. 26, 2009 (JP) 2009-152681

(51) Int. Cl. G06F 15/16

(52) U.S. Cl. 709/203

(57) ABSTRACT

A disclosed inheritance communication administrating apparatus including a state administration unit configured to receive a report in a certain timing from a first terminal apparatus, the report includes position data of a content received by the first terminal apparatus, and configured to store the position data, and a list sending unit configured to receive a request for a list from a second terminal, acquire the requested list from a menu server, determine whether there is the content which is being viewed and listened to by a user of the second terminal in reference to the position data, and add to the list the content which is being viewed and listened to as a candidate content and send the list to the second terminal.

### CROSS-REFERENCE TO RELATED APPLICATIONS

This patent application is based upon and claims the benefit of priority of the prior Japanese Patent Application No. 2009-152681 filed on Jun. 26, 2009, the entire contents of which are incorporated herein by reference.

### FIELD

A certain aspect of the embodiments discussed herein is related to a technique of delivering contents which may include audio data or video data or both.

### BACKGROUND

Japanese Laid-open Patent Publication No. 2007-6235 discloses an image content distribution service method capable of viewing desired movie software or image content software with a price desired by a user. According to Japanese Laid-open Patent Publication No. 2007-6235, mobile information communication terminals or information communication terminals to be operated by users, transmit order request information including a desired distribution fee indicating desired movie software or image content software, to an image content server. The image content server is designed to distribute the movie software or the image content software in response to requests made from the mobile information communication terminals, etc.

Japanese Laid-open Patent Publication No. 2009-55099 discloses a content viewing system in which a user can perform viewing of a desired content suitably. According to Japanese Laid-open Patent Publication No. 2009-55099, when contents being viewed by any one of a television receiver and a portable device in a content viewing system is viewed continuously by another television receiver or portable device, content information is shared between the television receiver and the portable device through communication via a television side communication section and a portable device side communication section by operating at least one of the television side operating section and the portable device side operating section so that the content can be viewed and listened to continuously on the other side depending on settings based on that content information.

### SUMMARY

According to an aspect of the embodiment, there is provided an inheritance communication administrating apparatus including a state administration unit configured to receive a report in a certain timing from a first terminal apparatus, the report includes position data of a content received by the first terminal apparatus, and configured to store the position data, and a list sending unit configured to receive a request for a list from a second terminal, acquire the requested list from a menu server, determine whether there is the content which is being viewed and listened to by a user of the second terminal in reference to the position data, and add to the list the content which is being viewed and listened to as a candidate content and send the list to the second terminal.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIG. 1 schematically illustrates an example system configuration which may include an inheritance communication administrating apparatus;

FIG. 2 schematically illustrates an example internal configuration of an image delivery server included in the example system configuration illustrated in FIG. 1;

FIG. 3 schematically illustrates an example internal configuration of a menu server included in the example system configuration illustrated in FIG. 1;

FIG. 4 schematically illustrates an example internal configuration of a first audio and visual (AV) terminal included in the example system configuration illustrated in FIG. 1;

FIG. 5 schematically illustrates an example internal configuration of a second audio and visual (AV) terminal included in the example system configuration illustrated in FIG. 1;

FIG. 6A is an example sequence diagram enabling a user to view and listen to an image with a mobile phone in the example system configuration illustrated in FIG. 1;

FIG. 6B is the example sequence diagram following FIG. 6A;

FIG. 7 is an example sequence diagram enabling a user to view and listen to an image with a mobile phone which requires authorization in the example system configuration illustrated in FIG. 1;

FIG. 8A is an example sequence diagram enabling a user to view and listen to an image with a network television in the example system configuration illustrated in FIG. 1;

FIG. 8B is the example sequence diagram following FIG. 8A;

FIG. 9 is an example sequence diagram enabling a user to view and listen to an image with a network television which requires authorization in the example system configuration illustrated in FIG. 1;

FIG. 10 illustrates an example system configuration which includes an inheritance communication administrating server of Embodiment 1;

FIG. 11 schematically illustrates an example internal configuration of an inheritance communication administrating server included in the example system configuration illustrated in FIG. 10;

FIG. 12A, FIG. 12B and FIG. 12C illustrate example data stored in a Web server unit of the inheritance communication administrating server;

FIG. 13 illustrates example data stored in a viewing and listening state administration unit of the inheritance communication administrating server;

FIG. 14 illustrates example data stored in an authentication unit of the inheritance communication administrating server;

FIG. 15 is example tabulated data of the inheritance communication administrating server stored in an AV terminal;

FIG. 16A is an example sequence diagram enabling a user to view and listen to an image with a mobile phone in the example system configuration illustrated in FIG. 10;

FIG. 16B is the example sequence diagram following FIG. 16A;

FIG. 16C is the example sequence diagram following FIG. 16B;

FIG. 17 illustrates an example data configuration of a communication message;

FIG. 18A and FIG. 18B are examples of a screen of an AV terminal displaying an image list;

FIG. 19 is an example sequence diagram enabling a user to view and listen to an image with a mobile phone which requires authorization in the example system configuration illustrated in FIG. 10;

FIG. 20A is an example sequence diagram enabling a user to view and listen to an image with a network television in the example system configuration illustrated in FIG. 10;

FIG. 20B is the example sequence diagram following FIG. 20A;

FIG. 20C is the example sequence diagram following FIG. 20B;

FIG. 21 is an example sequence diagram enabling a user to view and listen to an image with a network television which requires authorization in the example system configuration illustrated in FIG. 10; and

FIG. 22 is an example sequence diagram of ending viewing and listening in an AV terminal.

### DESCRIPTION OF EMBODIMENTS

Image delivery services to, for example, mobile phones and network televisions are carried out as described previously.

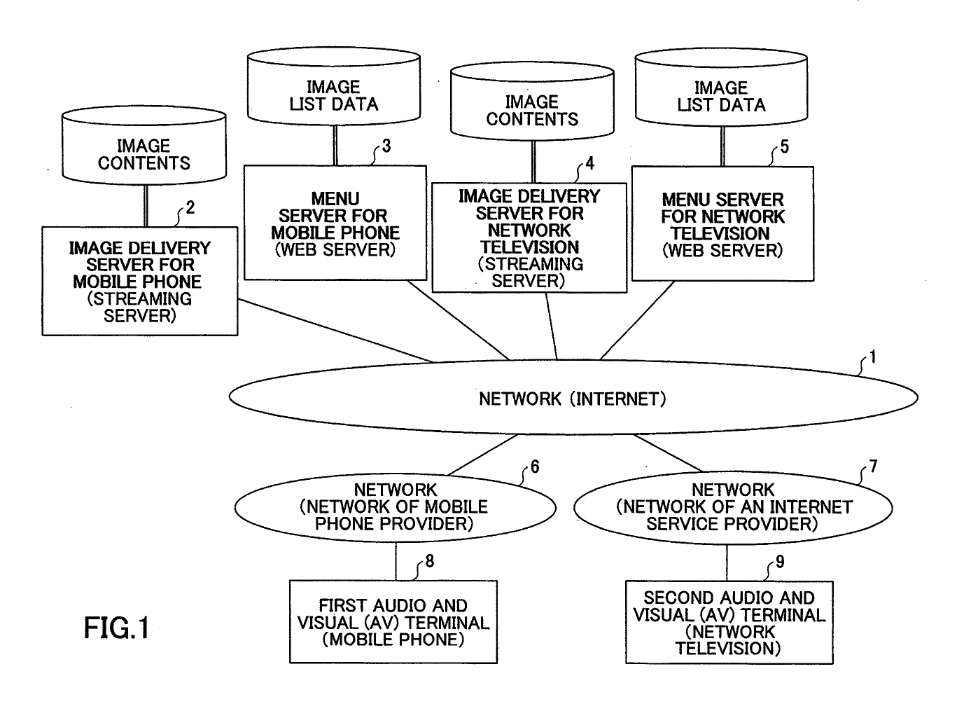

Referring to FIG. 1, an image delivery server for mobile phone 2, a menu server 3 for mobile phone 3, an image delivery server for network television 4 and a menu server for network television 5 are connected to a network 1 such as the Internet. The image delivery server for mobile phone 2 has the function of a streaming server which provides image contents in response to a request from the mobile phones via the network 1. The menu server for mobile phone 3 has the function of a Web server and provides image list data to mobile phones in response to the requests from the mobile phones. The image delivery server for mobile phone 4 has the function of a streaming server which provides image contents in response to requests from the network televisions via the network 1. The menu server for network television 5 has the function of a Web server and provides image list data to network televisions in response to the request from the network televisions.

A network 6 maintained by a mobile phone provider and a network 7 maintained by an Internet service provider (ISP) are connected to the network 1. A first audio and visual (AV) terminal 8 such as the mobile phone is connected to the image delivery server for mobile phone 2 and the menu server for mobile phone 3 via the network 6 and the network 1. A second audio and visual (AV) terminal 9 such as a network television is connected to the image delivery server for mobile phone 4 and the menu server for mobile phone 5 via the network 7 and the network 1.

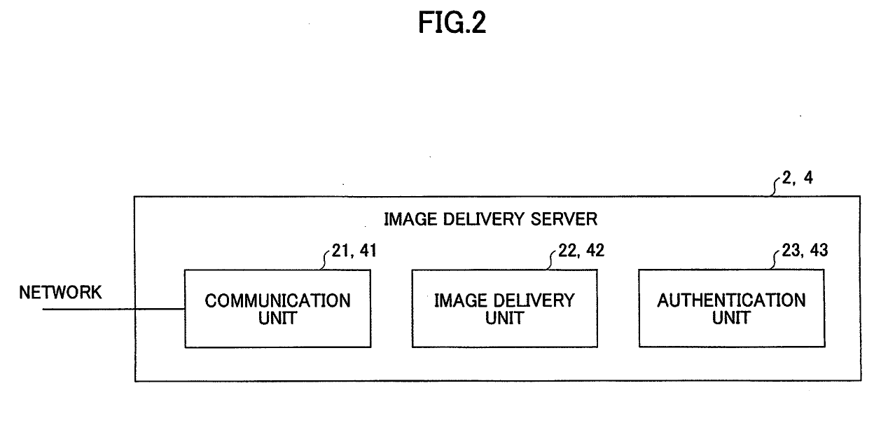

FIG. 2 schematically illustrates an example internal configuration of an image delivery server such as the image delivery server for mobile phone 2 and the image delivery server for network television 7, included in the example system configuration illustrated in FIG. 1. Referring to FIG. 2, the image delivery server for mobile phone 2 includes a communication unit 21 configured to communicate via a network and an image delivery unit 22 configured to carry out a streaming delivery. The image delivery server for network television 4 includes a communication unit 41 configured to communicate via a network and an image delivery unit 42 configured to carry out a streaming delivery. The image delivery server for mobile phone 2 further includes an authentication unit 23 configured to carry out an authentication process when authentication is carried out in accessing the other servers. The image delivery server for network television 4 further includes an authentication unit 43 configured to carry out an authentication process when authentication is carried out in accessing the other servers.

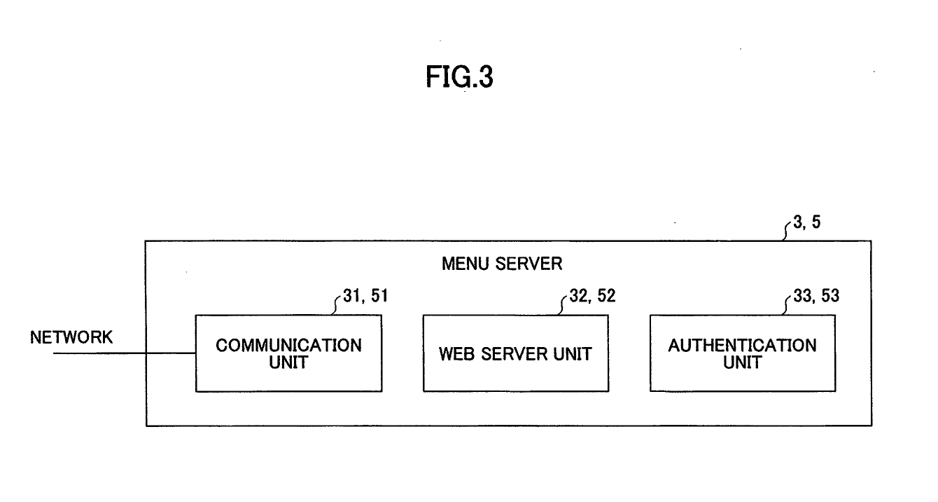

FIG. 3 schematically illustrates an example internal configuration of a menu server such as the menu server for mobile phone 3 and the menu server for network television 5, included in the example system configuration illustrated in FIG. 1. Referring to FIG. 3, the menu server for mobile phone 3 includes a communication unit 31 configured to communicate via the network and a Web server unit 32 configured to provide a Web page with a source of request. The menu server for network television 5 includes a communication unit 51 configured to communicate via the network and a Web server unit 52 configured to provide a Web page with a source of request. The menu server for mobile phone 3 further includes an authentication unit 33 configured to carry out an authentication process when authentication is carried out in accessing the other servers. The menu server for mobile phone 5 further includes an authentication unit 53 configured to carry out an authentication process when authentication is carried out in accessing the other servers.

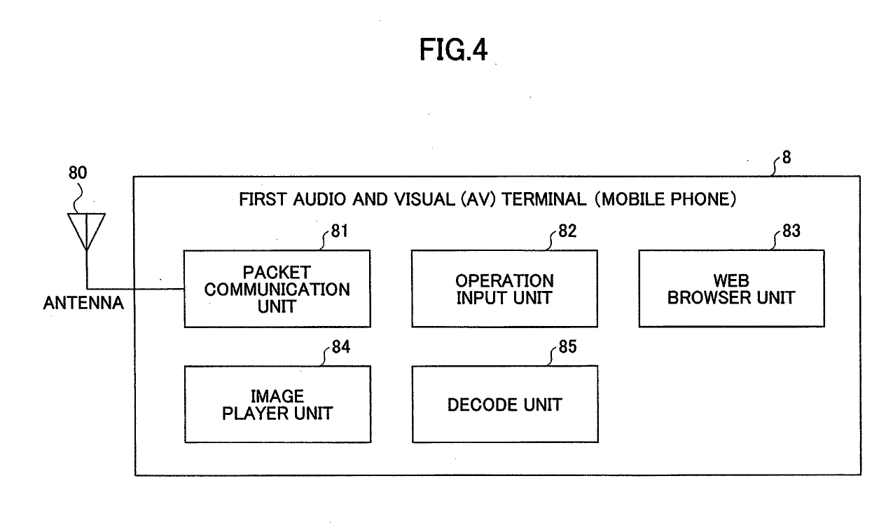

FIG. 4 schematically illustrates an example internal configuration of the first audio and visual (AV) terminal 8 such as a mobile phone included in the example system configuration illustrated in FIG. 1. Referring to FIG. 4, the first audio and visual (AV) terminal 8 includes an antenna 80 configured to input and output radio waves, a packet communication unit 81 configured to carry out packet communication with radio waves, an operation input unit 82 configured to receive a user's operation, and a Web browser unit 83 configured to browse Web pages from Web servers. The first audio and visual (AV) terminal 8 includes an image player unit 84 configured to reproduce acquired image contents and a decode unit 85 configured to extend compressed data when the image contents are reproduced.

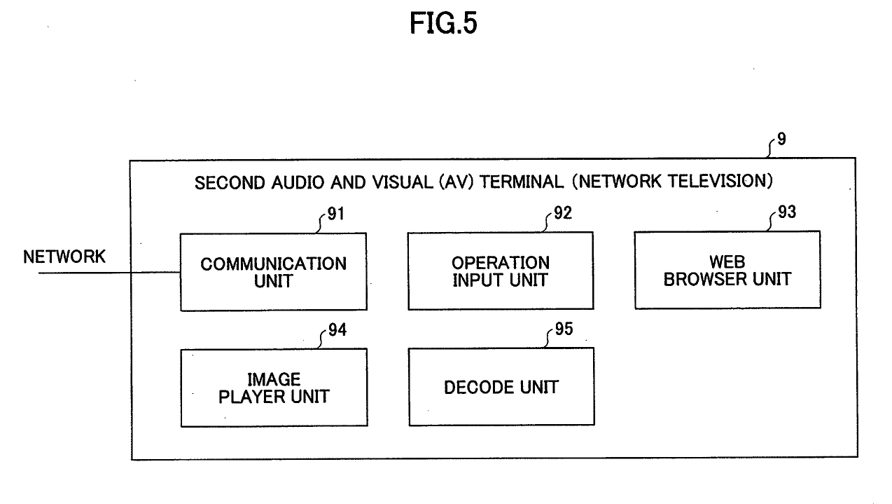

FIG. 5 schematically illustrates an example internal configuration of the second audio and visual (AV) terminal 9 such as a network television included in the example system configuration illustrated in FIG. 1. Referring to FIG. 5, the second audio and visual (AV) terminal 9 includes a communication unit 91 configured to carry out packet communication via a network, an operation input unit 92 configured to receive a user's operation, and a Web browser unit 93 configured to browse Web pages from Web servers. The second audio and visual (AV) terminal 9 includes an image player unit 94 configured to reproduce acquired image contents and a decode unit 95 configured to extend compressed data when the image contents are reproduced.

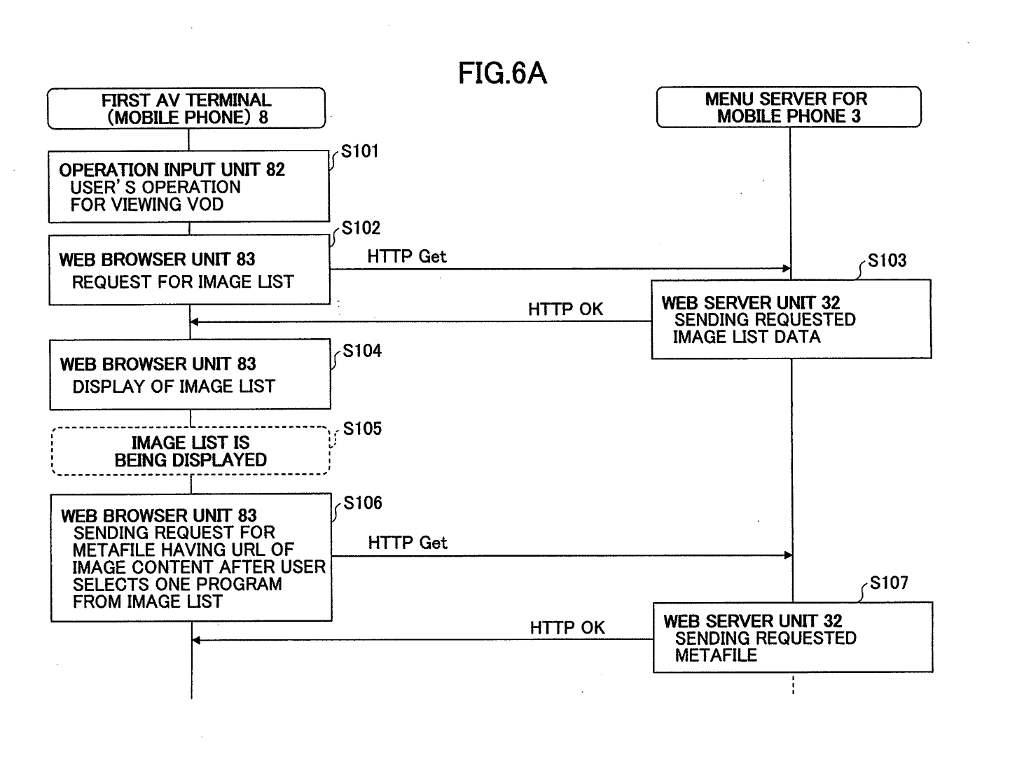

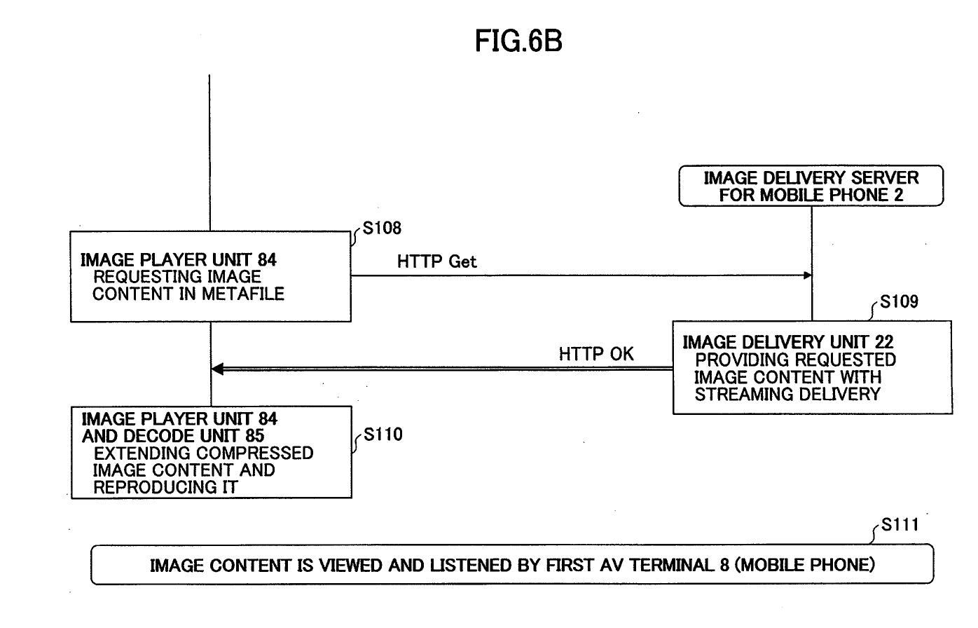

FIG. 6A and FIG. 6B are, in combination, an example sequence diagram enabling a user to view and listen to an image with a mobile phone in the example system configuration illustrated in FIG. 1.

Referring to FIG. 6A, when the user operates the operation input unit 82 of the first audio and visual (AV) terminal 8 such as the mobile phone in order to view images with Video On Demand (VOD) in step S101, the Web browser unit 83 requests the menu server for mobile phone 3 to send an image list in step S102.

In response to the request, the Web server unit 32 of the menu server for mobile phone 3 sends requested image list data to the Web browser unit 83 of the first audio and visual (AV) terminal 8 in step S103.

The Web browser unit 83 of the first audio and visual (AV) terminal 8 displays the image list based on the sent image list data in step S104. Thus, the image list is displayed on the screen of the first audio and visual (AV) terminal 8 in step S105.

Next, after the user selects one program from the image list, the Web browser unit 83 of the first audio and visual (AV) terminal 8 sends a request for a metafile having the URL of the corresponding image content to the menu server for mobile phone 3 in step S106.

In response to the request, the Web server unit 32 of the menu server for mobile phone 3 sends the requested metafile to the Web browser unit 83 of the first audio and visual (AV) terminal 8 in step S107.

Referring to FIG. 6B, the image player unit 84 of the first audio and visual (AV) terminal 8 requests the image content designated by the metafile from the image delivery server for mobile phone 2 in step S108.

In response to the request, the image delivery unit 22 of the image delivery server for mobile phone 2 provides the requested image content with streaming delivery to the first audio and visual (AV) terminal 8 in step S109.

The image player unit 84 and the decode unit 85 of the first audio and visual (AV) terminal 8 extend the compressed image content received by the first audio and visual (AV) terminal 8 and reproduce the extended image content in step S110. Thus, the image content can be viewed and listened to by the first audio and visual (AV) terminal 8 in step S111.

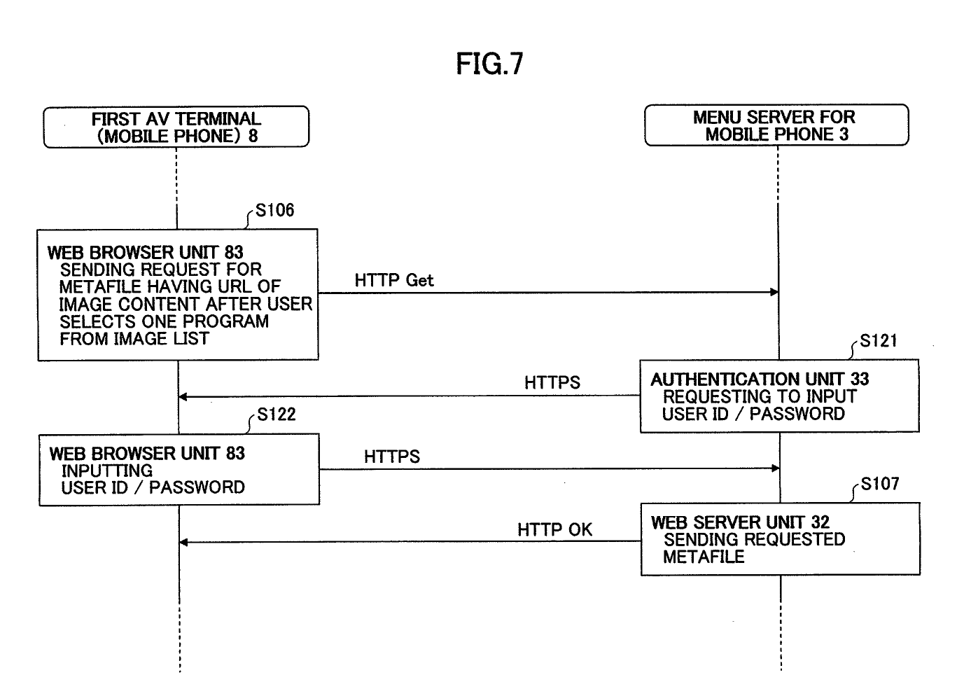

FIG. 7 is an example sequence diagram enabling a user to view and listen to an image with a mobile phone which requires authorization in the example system configuration illustrated in FIG. 1.

Referring to FIG. 7, additional processes are inserted between steps S106 and S107. The other steps S101 to S111 are similar to those in FIG. 6A and FIG. 6B. Referring to FIG. 7, after the metafile is requested from the Web browser unit 83 of the first audio and visual (AV) terminal 8 in step S106, the authentication unit 33 of the menu server for mobile phone 3 requests the Web browser unit 83 of the first audio and visual (AV) terminal 8 to input a user ID and a password in step S121.

In response to the request, the user inputs the user ID and the password, and the Web browser unit 83 of the first audio and visual (AV) terminal 8 sends the user ID and the password to the authentication unit 33 of the menu server for mobile phone 3 in step S122.

When the authentication is normally done, the Web server unit 32 of the menu server for mobile phone 3 sends the requested metafile to the Web browser unit 83 of the first audio and visual (AV) terminal 8 in step S107.

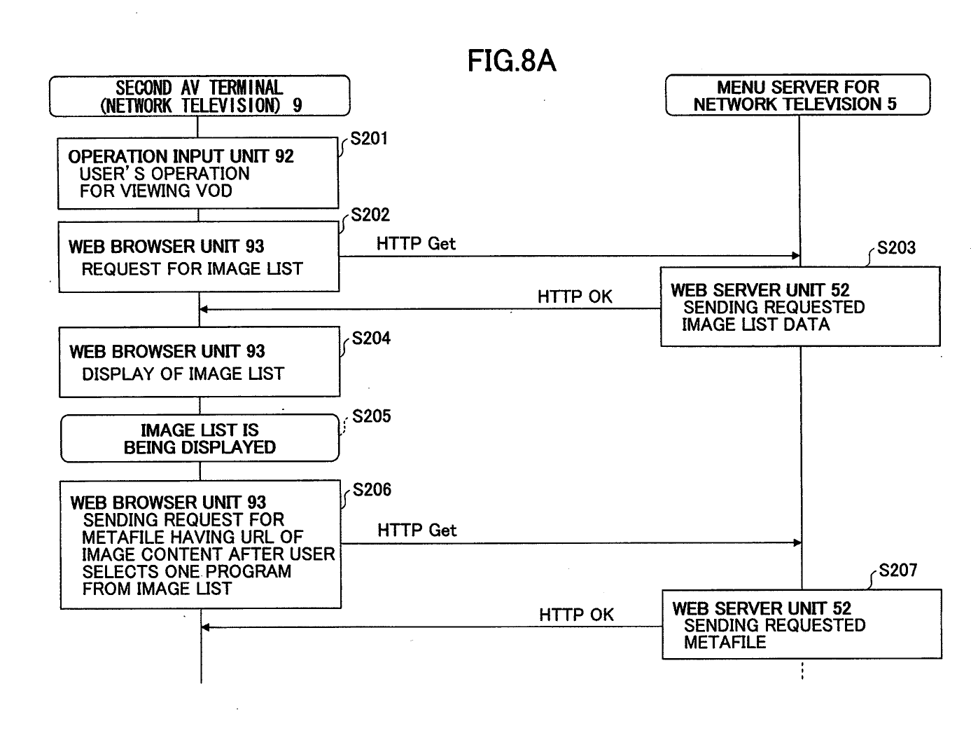

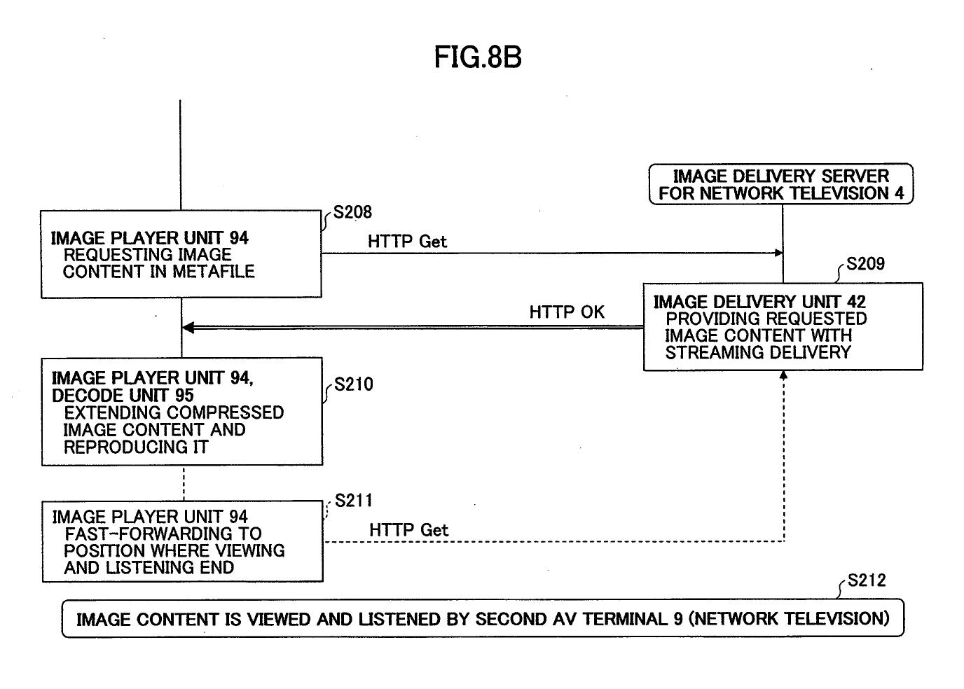

FIG. 8A and FIG. 8B are, in combination, an example sequence diagram enabling a user to view and listen to an image with a network television in the example system configuration illustrated in FIG. 1.

Referring to FIG. 8A, when the user operates the operation input unit 92 of the second audio and visual (AV) terminal 9 such as the network television in order to view images with Video On Demand (VOD) in step S201, the Web browser unit 93 requests the menu server for network television 5 to send an image list in step S202.

In response to the request, the Web server unit 52 of the menu server for network television 5 returns requested image list data to the Web browser unit 93 of the second audio and visual (AV) terminal 9 in step S203.

The Web browser unit 93 of the second audio and visual (AV) terminal 9 displays the image list based on the sent image list data in step S204. Thus, the image list is displayed on the screen of the second audio and visual (AV) terminal 8 in step S205.

Next, after the user selects one program from the image list, the Web browser unit 93 of the second audio and visual (AV) terminal 9 requests a metafile having the URL of the corresponding image content from the menu server for network television 5 in step S206.

In response to the request, the Web server unit 52 of the menu server for network television 5 sends the requested metafile to the Web browser unit 93 of the second audio and visual (AV) terminal 8 in step S207.

Referring to FIG. 8B, the image player unit 94 of the second audio and visual (AV) terminal 9 requests the image content designated by the metafile from the image delivery server for network television 4 in step S208.

In response to the request, the image delivery unit 42 of the image delivery server for network television 4 provides the requested image content with streaming delivery to the second audio and visual (AV) terminal 9 in step S209.

The image player unit 94 and the decode unit 95 of the second audio and visual (AV) terminal 9 extend the compressed image content received by the second audio and visual (AV) terminal 9 and reproduce the extended image content in step S210.

When the user operates the image player unit 94 of the second audio and visual (AV) terminal 9 to request fast-forwarding of the image content up to a position of the image content, in which the user has viewed and listened to the image content in step S211, the image delivery server for network television 4 sends the image content from the position. Then, the second audio and visual (AV) terminal 9 receives delivery of the image content from the position. Thus, the image content can be viewed and listened to by the second audio and visual (AV) terminal 9 in step S212.

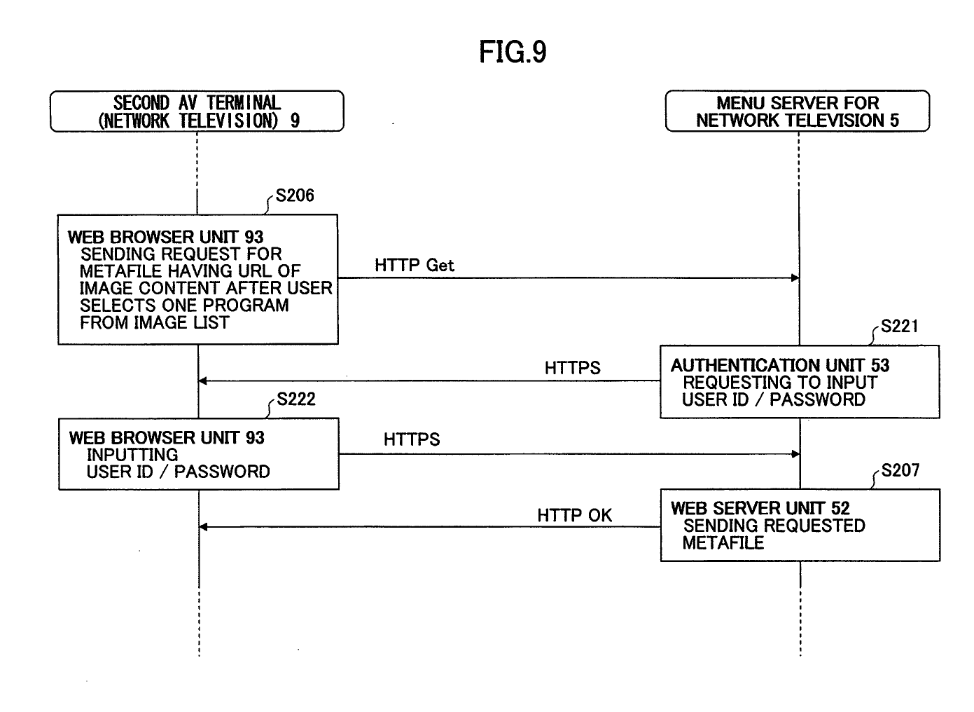

FIG. 9 is an example sequence diagram enabling a user to view and listen to an image with a network television which requires authorization in the example system configuration illustrated in FIG. 1.

Referring to FIG. 9, additional processes are inserted between steps S206 and S207. The other steps S201 to S212 are similar to those in FIG. 8A and FIG. 8B. Referring to FIG. 9, after the metafile is requested by the Web browser unit 93 of the second audio and visual (AV) terminal 9 in step S206, the authentication unit 53 of the menu server for network television 5 requests the Web browser unit 93 of the second audio and visual (AV) terminal 9 to input a user ID and a password in step S221.

In response to the request, the user inputs the user ID and the password, and the Web browser unit 93 of the second audio and visual (AV) terminal 9 sends the user ID and the password to the authentication unit 53 of the menu server for network television 5 in step S222.

When the authentication is normally done, the Web server unit 52 of the menu server for network television 5 sends the requested metafile to the Web browser unit 93 of the second audio and visual (AV) terminal 9 in step S207.

However, the user may additionally operate the image player unit 94 of the second audio and visual (AV) terminal 9 to request fast-forwarding of the image content up to the position of the image content, in which the user has viewed and listened to the image content with the first audio and visual (AV) terminal 8 in step S211 as described above. For example, it is convenient for a user to continuously view and listen to a certain image content using different AV terminals without additional operations by a user on all of the different AV terminals in the example system configuration illustrated in FIG. 1.

For example, when the user is getting back from the outside to his or her home while viewing and listening to image contents such as a movie with a mobile phone, the user may wish to view and listen to the image content with the larger screen of a network television.

To satisfy the user's wish, the following complicated operations may be carried out:
(1) Turning on the network television;
(2) Browsing a homepage of an image provider;
(3) Following predetermined authentication processes such as a log-in;
(4) Finding the image content which has been viewed and listened to from the image list;
(5) Reproducing the image content; and
(6) Forwarding the image content to a scene next to a scene in which previous viewing and listening have been finished using fast-forwarding or the like.

Preferred embodiments of the present invention will be explained with reference to accompanying drawings.

### <Configuration>

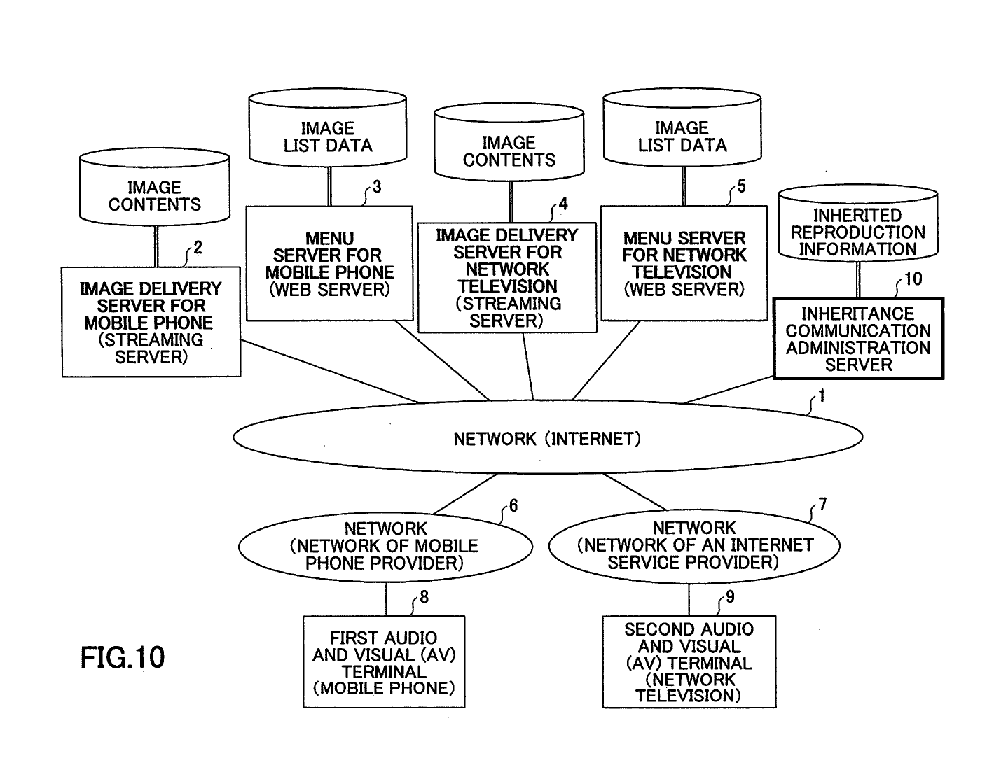

FIG. 10 illustrates an example system configuration of Embodiment 1. Referring to FIG. 10, the same reference symbols as those in FIG. 1 are used for portions the same as or similar to those in FIG. 1, and description of these portions are omitted. The system illustrated in FIG. 10 further includes an inheritance communication administrating server 10 in addition to the system illustrated in FIG. 1. The inheritance communication administrating server 10 has a function of administrating inherited reproduction information (viewing and listening information), and transferring the viewing and listening information for a user in one AV terminal to another AV terminal used next by the user.

Referring to FIG. 10, an image delivery server for mobile phone 2, a menu server for mobile phone 3, an image delivery server for network television 4, and a menu server for network television 5 are connected to the network 1 such as the Internet. The image delivery server for mobile phone 2 has a function of a streaming server which provides image contents in response to requests from mobile phones via the network 1. The menu server for mobile phone 3 has a function of a Web server and provides image list data to the mobile phones in response to the requests from the mobile phones via the network 1. The image delivery server for mobile phone 4 has the function of a streaming server which provides image contents in response to requests from the network televisions via the network 1. The menu server for network television 5 has the function of a Web server and provides image list data to network televisions in response to the requests from the network televisions via the network 1.

The inheritance communication administrating server 10 is connected to the network 1. The number of the inheritance communication administrating servers 10 may be single or plural. When the number of the inheritance communication administrating servers 10 is plural, the inheritance communication administrating servers 10 are compatible with a network such as the network for a mobile phone provider and the network for an Internet service provider (ISP). The inheritance communication administrating server 10 administrates each viewing and listening state of users as inherited reproduction information. When there are plural inheritance communication administrating servers 10, the inheritance communication administrating servers 10 mutually communicate to transfer the viewing and listening information. Then, the viewing and listening information may undergo decentralized administration.

A network 6 maintained by the mobile phone provider and a network 7 maintained by the Internet service provider (ISP) may be connected to the network 1. A first audio and visual (AV) terminal 8 such as the mobile phone is connected to the image delivery server for mobile phone 2 and the menu server for mobile phone 3 via the network 6 and the network 1. A second audio and visual (AV) terminal 9 such as the network television is connected to the image delivery server for mobile phone 4 and the menu server for mobile phone 5 via the network 7 and the network 1.

The configuration of the image delivery server such as the image delivery server for mobile phone 2 and the image delivery server for network television 4 is similar to that described with reference to FIG. 2. The configuration of a menu server such as a menu server for mobile phone 3 and a menu server for network television 5 is similar to the configuration of the menu server illustrated with reference to FIG. 3. The configuration of the first audio and visual (AV) terminal 8 is similar to the configuration of the first audio and visual (AV) terminal 8 illustrated with reference to FIG. 4. The configuration of the second audio and visual (AV) terminal 9 is similar to the configuration of the first audio and visual (AV) terminal 9 illustrated with reference to FIG. 5.

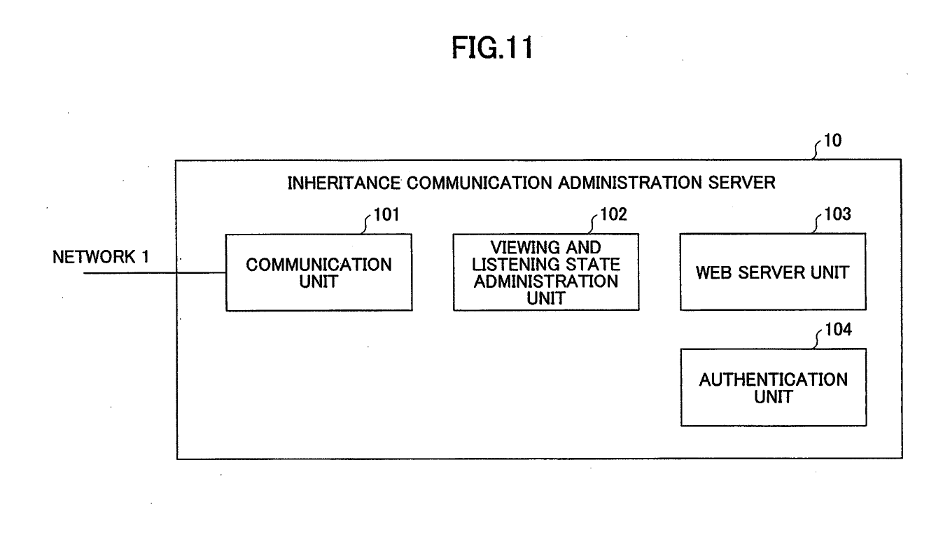

FIG. 11 schematically illustrates an example internal configuration of the inheritance communication administrating server 10 included in the example system configuration illustrated in FIG. 10. Referring to FIG. 11, the inheritance communication administrating server 10 includes a communication unit 101 configured to communicate via a network, and a viewing and listening state administration unit 102 configured to administrate users respectively. Further, the inheritance communication administrating server 10 includes a Web server unit 103 configured to provide a Web page to a source of request and an authentication unit 104 configured to carry out predetermined authentication for server accessing.

Information to be administrated in the inheritance communication administrating server 10 and functions of the inheritance communication administrating server 10 are as follows. Items (1) to (3), (5) and (6) are information or functions administrated respectively for users. Item (4) is information used by the system in common.

(1) Store and administration of information used for continuous viewing and listening such as identification of image contents which users are viewing and listening to and viewing positions (e.g. elapsed minutes after a start)

(2) Determination whether the users who request an image list view and listen to the image contents with another AV terminal

(3) Adding an image interface for the users who are viewing and listening with the other terminal of requesting the continuous viewing and listening

(4) Administration of the file name of the image content and the location of the content file

(5) Administration of log-in identifiers and passwords respectively for delivery providers and network service providers when the delivery providers or the network service providers act for the users to enable log-in or the like

(6) Functions of answering to an authentication request from the delivery providers or the network service providers on behalf of the users when the delivery providers or the network service providers act for the users to enable log-in or the like

Further, in a case where the AV terminal before changing a mode of viewing and listening to the image content is a mobile phone and the AV terminal after changing a mode of viewing and listening to the image content is a network television, and the following conditions are established, the inheritance may be enabled: (1) Connection providers are different, for example, the connection providers are a mobile provider and an Internet service provider; (2) Functions or performances of the AV terminals are different; or (3) Image delivery service providers having the image delivery servers are different.

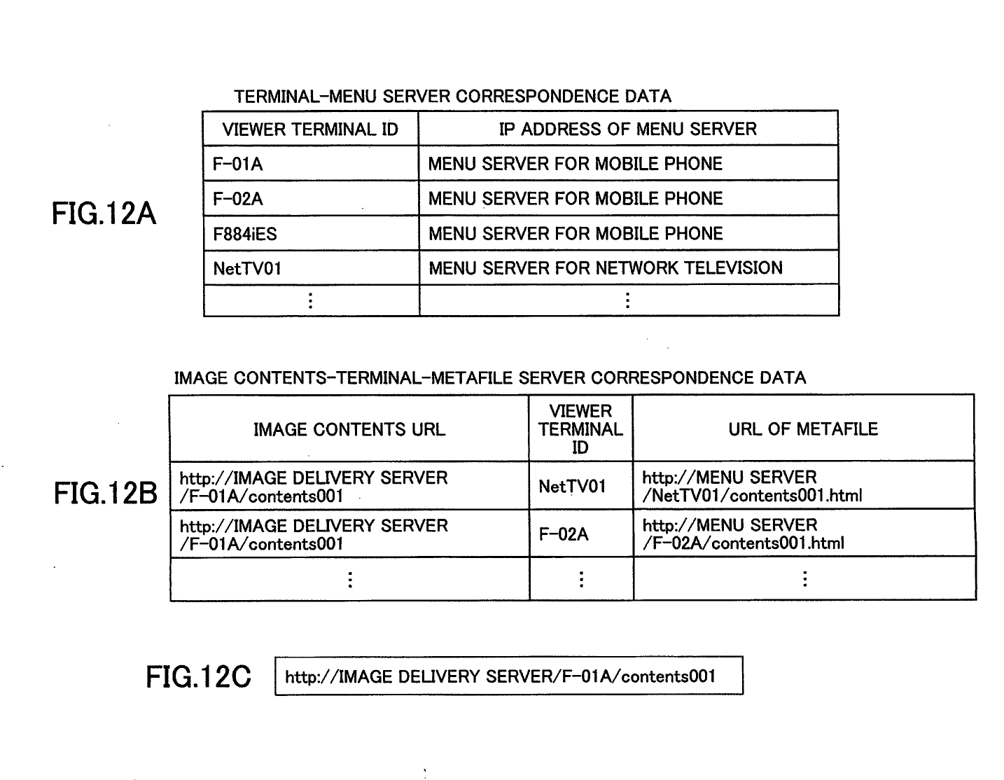

FIG. 12A, FIG. 12B and FIG. 12C illustrate example data stored in the Web server unit 103 of the inheritance communication administrating server 10.

FIG. 12A illustrates an example of terminal-menu server correspondence data which is a relationship between the IDs of the AV terminals and IP addresses of the menu servers. The Web server unit 103 of the inheritance communication administrating server 10 uses the terminal-menu server correspondence data to determine the menu server which the inheritance communication administrating server 10 accesses on behalf of the accessing AV terminal (i.e. the first audio and visual (AV) terminal 8 or the second audio and visual (AV) terminal 9 accessing the inheritance communication administrating server 10) depending on the type of the accessing AV terminal.

FIG. 12B illustrates image contents-terminal-metafile server correspondence data which is a relationship among the URLs of the image contents, the IDs of the AV terminals and the URLs of the metafiles. FIG. 12C illustrates an example content of the metafile which is referred with the URLs of the metafiles. Referring to FIG. 12C, the example content is an address in the image delivery server. An extension of the metafile is “.cpc” or the like. The Web server unit 103 of the inheritance communication administrating server 10 is used in setting a destination of link when a button for “continuous viewing and listening” is added to the image list which provides the image contents-terminal-metafile server correspondence data to the AV terminals. Based on the performances of the AV terminals, image contents of various modes prepared in conformity with screen sizes, frame rates, the number of colors, compression methods and delivery bands may be previously allocated. When the number of the image delivery servers is plural and the same image contents are stored in the image delivery servers, it is possible to optimally allocate image delivery servers to the AV terminals based on network paths, traffic of the network paths or the like.

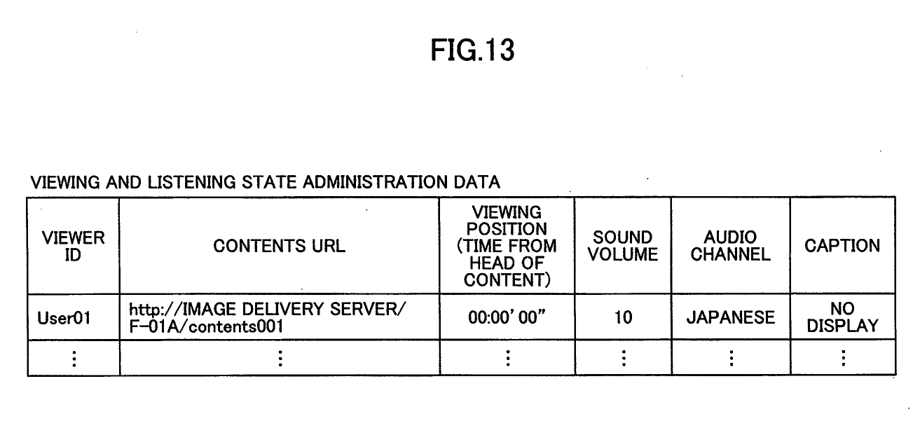

FIG. 13 illustrates example data stored in a viewing and listening state administration unit 102 of the inheritance communication administrating server 10 (hereinafter referred to as viewing and listening state administration data). The viewing and listening state administration data includes fields of “viewer ID”, “contents URL”, “viewing position”, “sound volume”, “audio channel” and “caption”. These fields are registered and administrated by the viewing and listening state administration unit 102 of the inheritance communication administrating server 10 based on a report from the AV terminal such as the first audio and visual (AV) terminal 8 and the second audio and visual (AV) terminal 9.

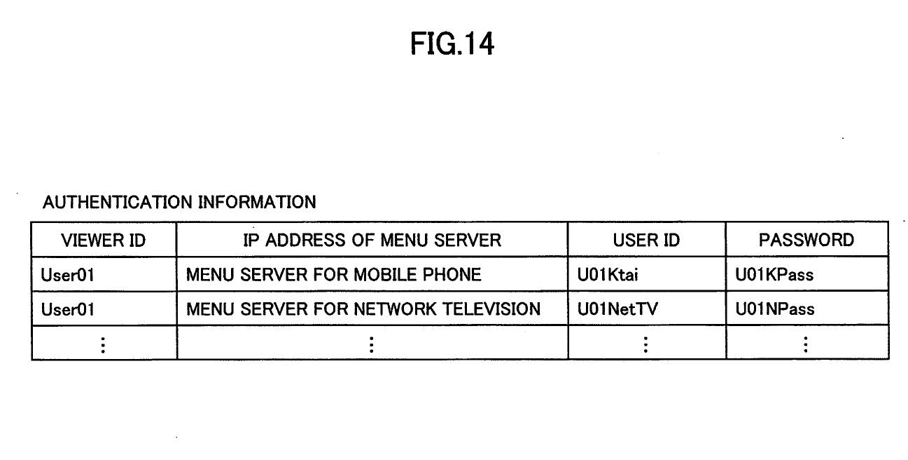

FIG. 14 illustrates example data stored in the authentication unit 104 of the inheritance communication administrating server 10. The authentication information (log-in information) includes the fields of “viewer ID”, “IP address of menu server”, “user ID”, “password” or the like.

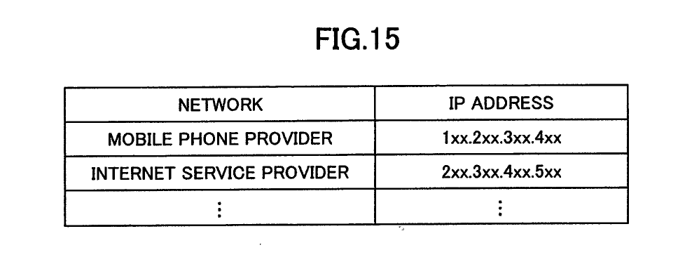

FIG. 15 is example tabulated data of the inheritance communication administrating server 10 stored in the AV terminal such as the first audio and visual (AV) terminal 8 and the second audio and visual (AV) terminal 9. When the number of the inheritance communication administrating servers 10 is one, it is sufficient to store only the IP address of the inheritance communication administrating server 10. However, when the number of the inheritance communication administrating servers 10 is plural, IP addresses may be selectable in correspondence with the network environment as illustrated in FIG. 15.

The AV terminal internally stores the AV terminal ID and the viewer ID.

### <Operation>

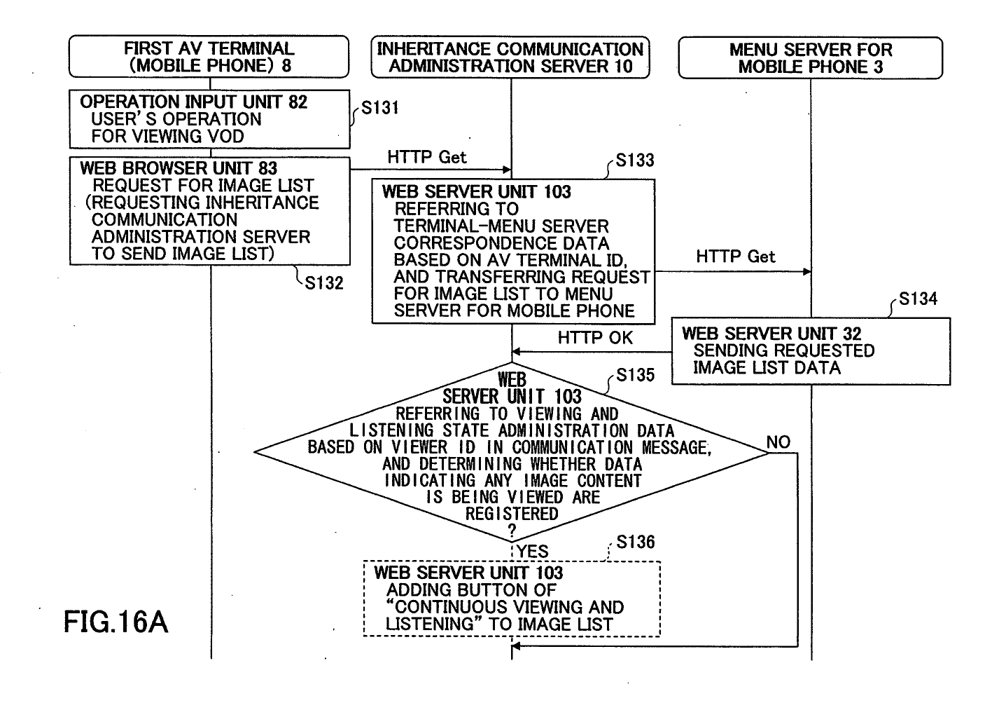

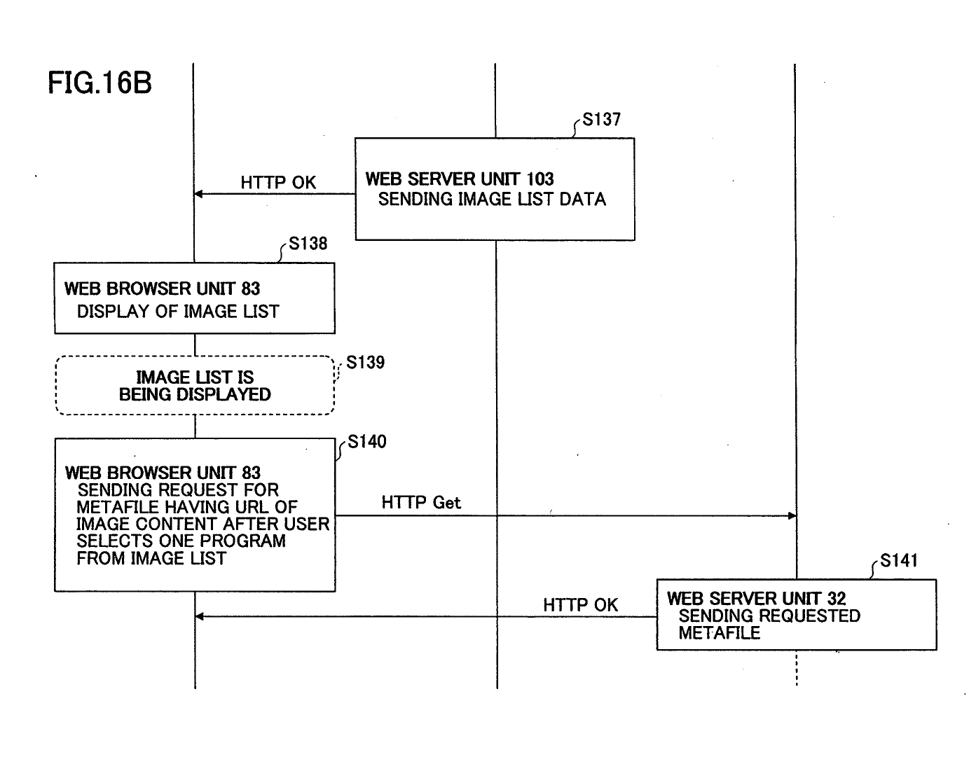

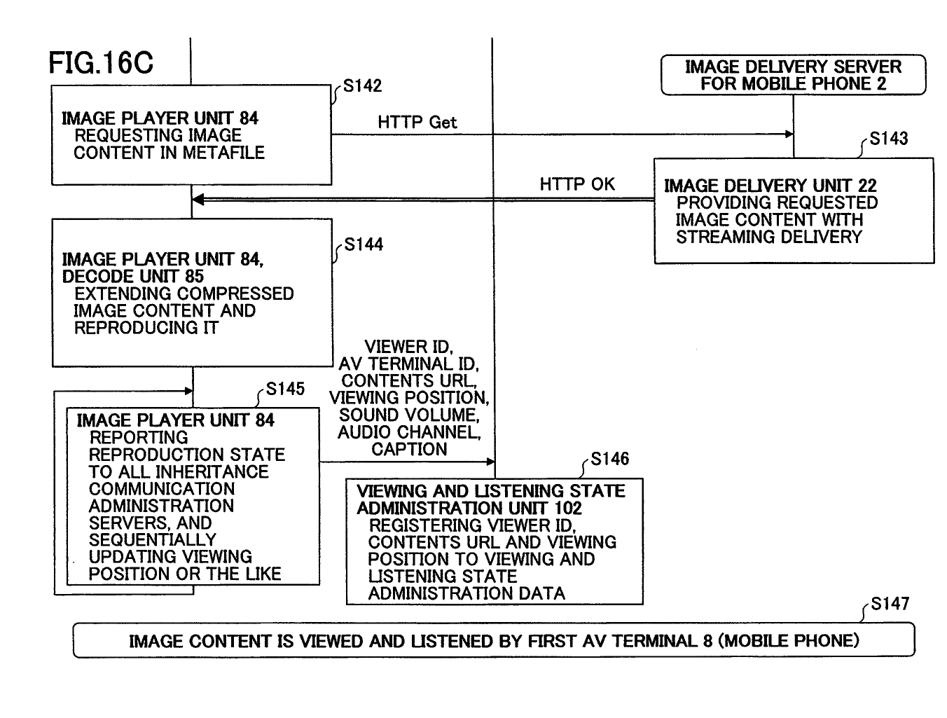

FIG. 16A is an example sequence diagram enabling a user to view and listen to an image with a mobile phone in the example system configuration illustrated in FIG. 10, FIG. 16B is the example sequence diagram following FIG. 16A, and FIG. 16C is the example sequence diagram following FIG. 16B.

Referring to FIG. 16A, when a user operates the operation input unit 82 of the first audio and visual (AV) terminal 8 such as the mobile phone in order to view images with Video On Demand (VOD) in step S131, the Web browser unit 83 requests the menu server for mobile phone 3 to send an image list in step S132. When the number of the inheritance communication administrating servers 10 is one, the first audio and visual (AV) terminal 8 requests the IP address of the inheritance communication administrating server 10 to send the image list. However, when the number of the inheritance communication administrating servers 10 is plural, the first audio and visual (AV) terminal 8 requests the inheritance communication administrating server 10 of a mobile phone provider to send the image list based on the tabulated data of the inheritance communication administrating servers illustrated in FIG. 15.

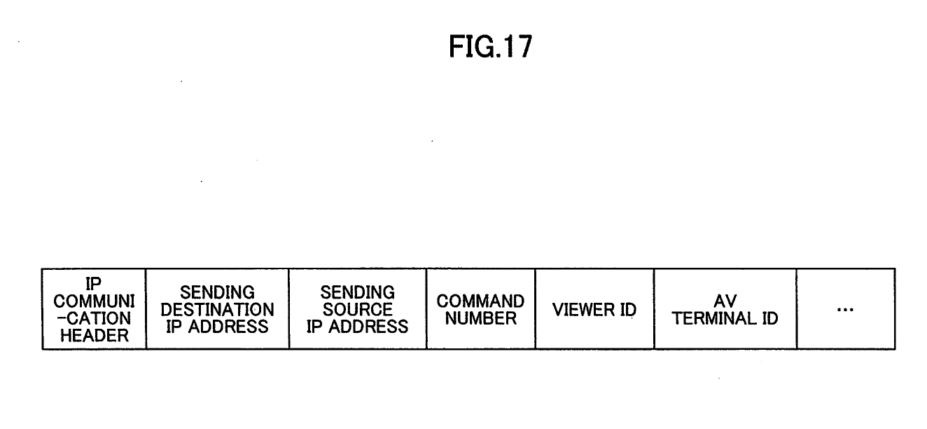

FIG. 17 illustrates an example data configuration of a communication message for requesting the image list from the first audio and visual (AV) terminal 8 to the inheritance communication administrating server 10. The communication message may include fields of “IP communication header”, “sending destination IP address”, “sending source IP address”, “command number”, “viewer ID” and “AV terminal ID”. The field of “command number” has a symbol for identifying a content of the communication message.

Referring back to FIG. 16A, the Web server unit 103 of the inheritance communication administrating server 10 refers to the terminal-menu server correspondence data illustrated in FIG. 12A based on the AV terminal ID inside the communication message illustrated in FIG. 17. Then, the Web server unit 103 transfers the request for the image list to the menu server for mobile phone 3 in step S133.

In response to the request for the image list, the Web server unit 32 of the menu server for mobile phone 3 sends the requested image list data to the inheritance communication administrating server 10 in step S134.

Then, the Web server unit 103 of the inheritance communication administrating server 10 refers to the viewing and listening state administration data illustrated in FIG. 13 based on the viewer ID of the communication message illustrated in FIG. 17, and determines whether data indicating any image content is being viewed are registered in step S135. Referring to FIG. 16A, when the data indicating that the any image content is being viewed is registered in the viewing and listening state administration data illustrated in FIG. 13 in YES of step S135, a button of “continuous viewing and listening” is added to the image list in step S136.

Next, it is assumed that the data indicating that the any image content is being viewed are not registered in the viewing and listening state administration data in NO of step S135. Referring to FIG. 16B, the Web server of the inheritance communication administrating server 10 does not modify the image data list acquired from the menu server for mobile phone 3. Thereafter, the image list data is sent to the Web browser unit 83 of the first audio and visual (AV) terminal 8 in step A137.

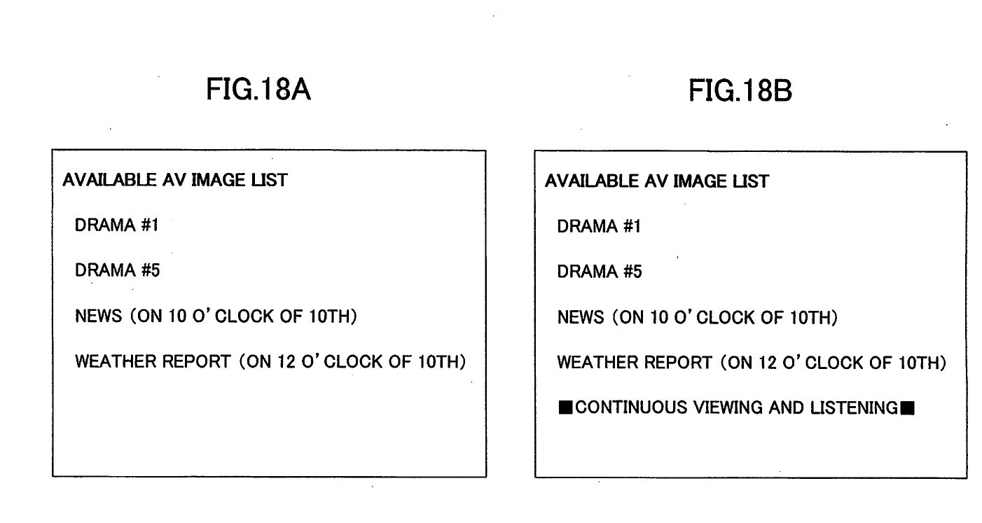

The Web browser unit 83 of the first audio and visual (AV) terminal 8 displays the image list based on the sent image list data in step S138. Thus, the image list is displayed on the screen of the first audio and visual (AV) terminal 8 in step S139. FIG. 18A and FIG. 18B illustrate examples of screens of the AV terminal displaying available image lists.

Referring back to FIG. 16B, after the user selects one program from the image list, the Web browser unit 83 of the first audio and visual (AV) terminal 8 requests a metafile having the URL of the corresponding image content from the menu server for mobile phone 3 in step S140.

In response to the request for the metafile, the Web server unit 32 of the menu server for mobile phone 3 sends the requested metafile to the Web browser unit 83 of the first audio and visual (AV) terminal 8 in step S141.

Referring to FIG. 16C, the image player unit 84 of the first audio and visual (AV) terminal 8 requests the image content designated by the metafile from the image delivery server for mobile phone 2 in step S142.

In response to the request for the image content, the image delivery unit 22 of the image delivery server for mobile phone 2 provides the requested image content with streaming delivery to the first audio and visual (AV) terminal 8 in step S143.

The image player unit 84 and the decode unit 85 of the first audio and visual (AV) terminal 8 extend the compressed image content received by the first audio and visual (AV) terminal 8 and reproduce the extended image content in step S144.

The image player unit 84 of the first audio and visual (AV) terminal 8 reports a reproduction state to the inheritance communication administrating server 10 to update in certain timing the viewing position or the like in step S145. The content of the report from the image player unit 84 of the first audio and visual (AV) terminal 8 to the inheritance communication administrating server 10 includes the viewer ID, the AV terminal ID, the contents URL, the viewing position, the sound volume, the audio channel, the caption or the like.

In response to the report and update, the viewing and listening state administration unit 102 of the inheritance communication administrating server 10 registers the viewer ID, the contents URL, the viewing position, the sound volume, the audio channel, the caption or the like in the viewing and listening state administration data illustrated in FIG. 13 in step S146.

Thus, the image content can be viewed and listened to with the first audio and visual (AV) terminal 8 in step S147.

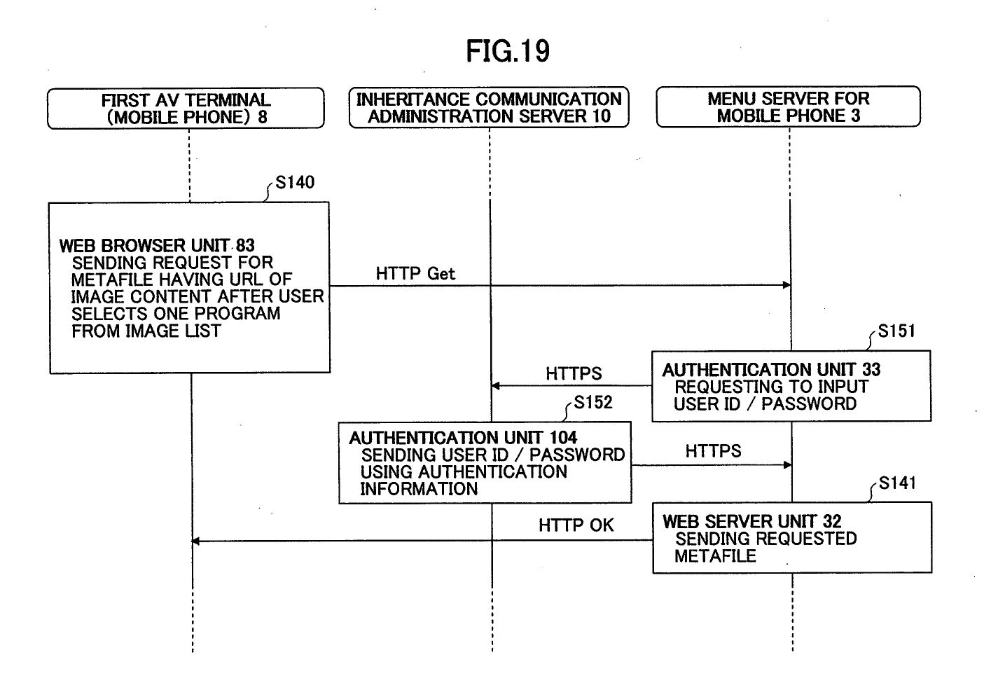

FIG. 19 is an example sequence diagram enabling a user to view and listen to an image with a mobile phone which requires authorization in the example system structure illustrated in FIG. 10. Referring to FIG. 19, additional processes are inserted between steps S140 and S141 in FIG. 16B. The other steps S131 to S147 are similar to those in FIG. 16A to FIG. 16C.

Referring to FIG. 19, after the metafile is requested by the Web browser unit 83 of the first audio and visual (AV) terminal 8 in step S140, the authentication unit 33 of the menu server for mobile phone 3 requests the Web browser unit 83 of the first audio and visual (AV) terminal 8 to input a user ID and a password in step S151.

In response to the request, the authentication unit 104 of the inheritance communication administrating server 10 uses the authentication information illustrated in FIG. 14 to send the user ID and the password to the authentication unit 33 of the menu server for mobile phone 3 in step S152.

When the authentication is normally done, the Web server unit 32 of the menu server for mobile phone 3 sends the requested metafile to the Web browser unit 83 of the first audio and visual (AV) terminal 8 in step S141.

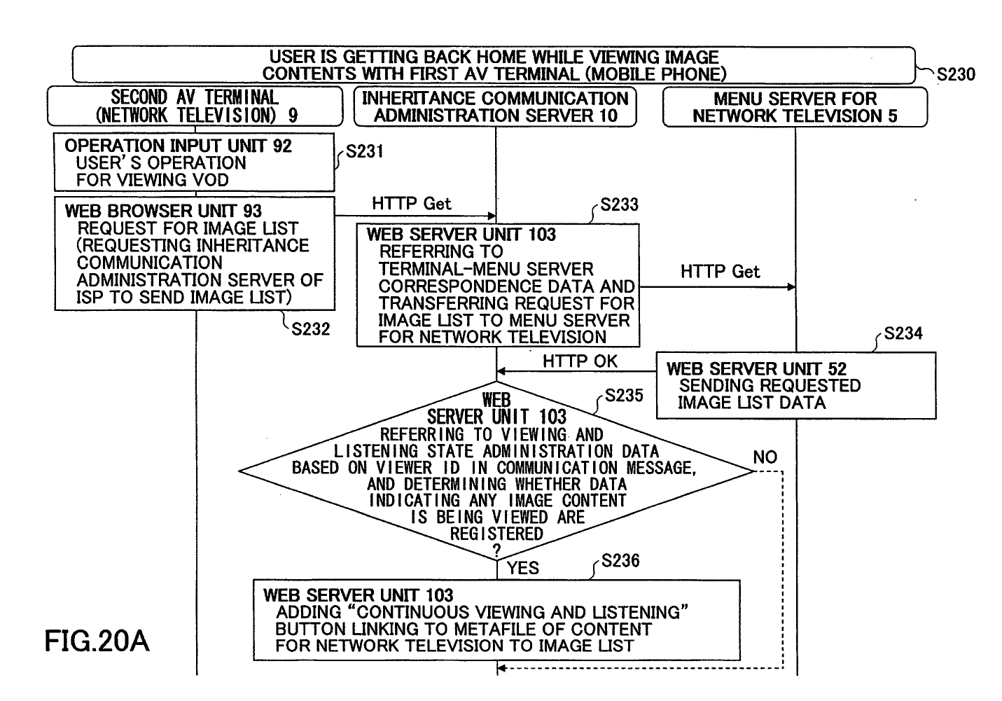

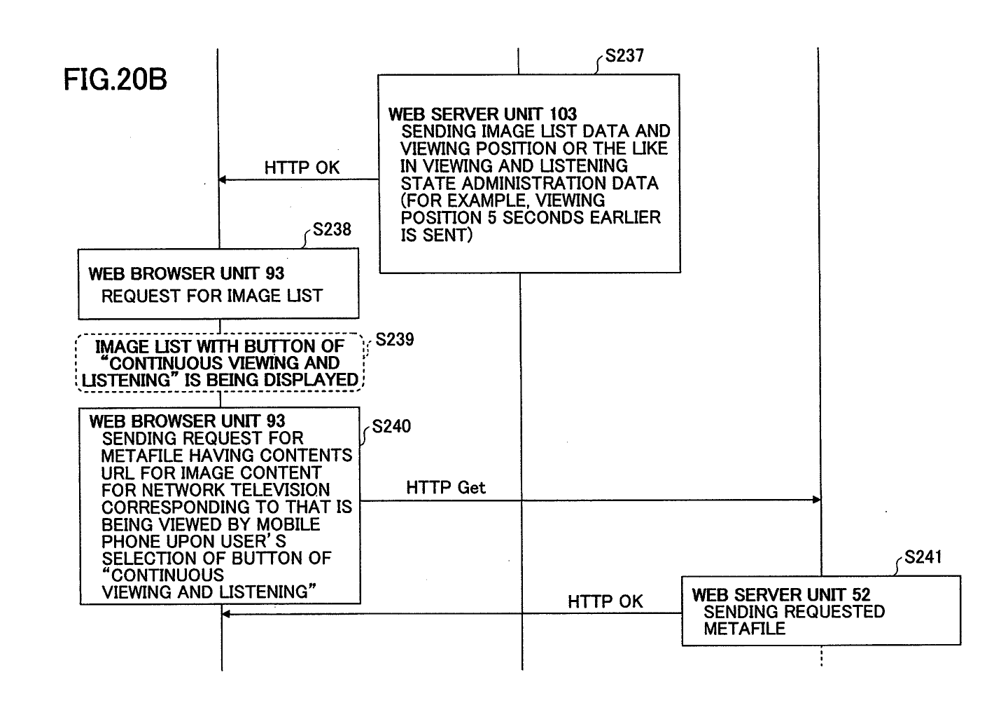

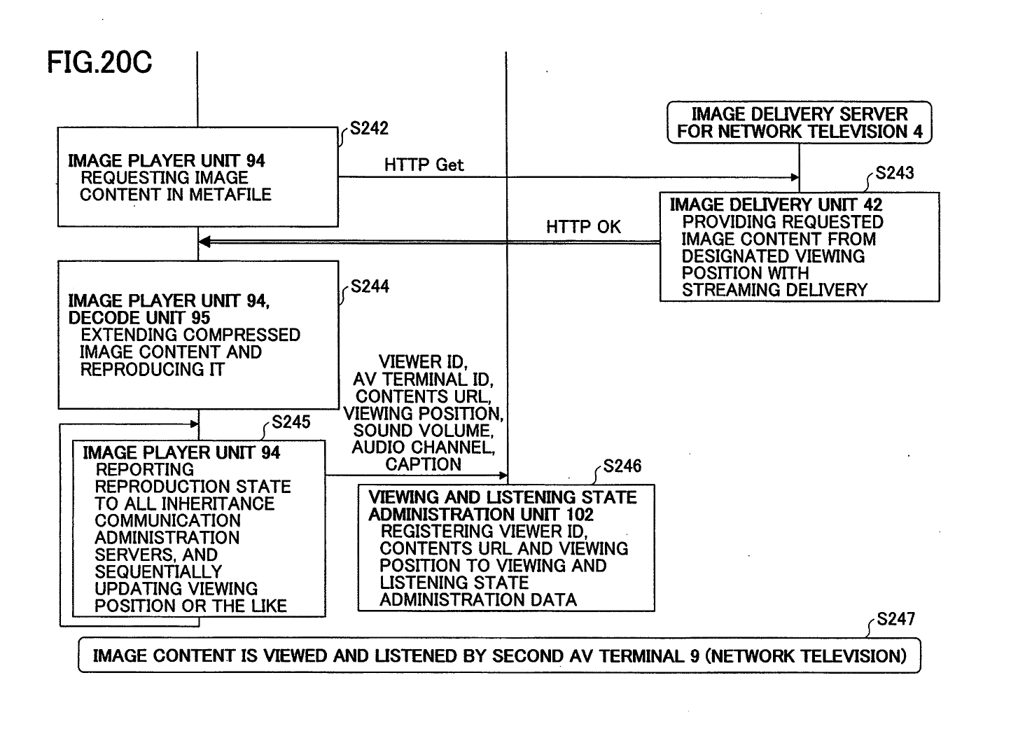

FIG. 20A to FIG. 20C are, in combination, an example sequence diagram enabling a user to view and listen to an image with a network television in the example system structure illustrated in FIG. 10.

Referring to FIG. 20A, it is assumed that a user is getting back from the outside to his or her home while viewing and listening to image contents with a first audio and visual (AV) terminal 8 such as a mobile phone in step S230.

Referring to FIG. 20A, when the user operates the operation input unit 92 of the second audio and visual (AV) terminal 9 such as the network television in order to view images with Video On Demand (VOD) in step S231, the Web browser unit 93 requests the menu server for network television 5 to send an image list in step S232. When the number of the inheritance communication administrating servers 10 is one, the second audio and visual (AV) terminal 9 requests the IP address of the inheritance communication administrating server 10 to send the image list. However, when the number of the inheritance communication administrating servers 10 is plural, the second audio and visual (AV) terminal 9 requests the inheritance communication administrating server 10 of an Internet service provider (ISP) to send the image list based on the tabulated data of the inheritance communication administrating servers illustrated in FIG. 15.

In response to the request for the image list, the Web server unit 103 of the inheritance communication administrating server 10 refers to the terminal-menu server correspondence data illustrated in FIG. 12A based on the AV terminal ID inside the communication message illustrated in FIG. 17. Then, the Web server unit 103 transfers the request for the image list to the menu server for network television 5 in step S233.

In response to the request for the image list, the Web server unit 52 of the menu server for network television 5 sends the requested image list data to the inheritance communication administrating server 10 in step S234.

Then, the Web server unit 103 of the inheritance communication administrating server 10 refers to the viewing and listening state administration data illustrated in FIG. 13 based on the viewer ID of the communication message illustrated in FIG. 17, and determines whether data indicating image content is being viewed is registered in step S235. When the data indicating image content is being viewed is not registered in NO of step S235, the image list data are not processed. It is assumed here that the data indicating image content is being viewed is registered.

In a case where the data indicating image content is being viewed are registered in YES of step S235, the Web server unit 103 of the inheritance communication administrating server 10 adds the button of “continuous viewing and listening”. As the destination of the link of the button of “continuous viewing and listening”, the metafile of the corresponding content for network television is set in step S236. Said differently, the URL of the corresponding metafile of the image content for network television is acquired from the image contents-terminal-metafile server correspondence data illustrated in FIG. 12B, based on the AV terminal ID and the contents URL of the image content being viewed in the viewing and listening state administration data illustrated in FIG. 13.

Referring to FIG. 20B, the Web server unit 103 of the inheritance communication administrating server 10 sends the image list data, the viewing position or the like to the Web browser unit 93 of the second audio and visual (AV) terminal 9 in step S237. A viewing position in the network television may be set earlier than the viewing position in the mobile phone by a predetermined time, e.g. 5 seconds, in consideration of passing over viewing and listening to the image contents when the AV terminal is changed from the mobile phone to the network television. Further, it is possible to send part of information of the image data to the AV terminals in conformity with the performance of the AV terminals. The viewing and listening information may be only a part or all of the image, only a part or all of the sound, or a part or all of the image and the sound.

The Web browser unit 93 of the second audio and visual (AV) terminal 9 displays the image list based on the sent image list data in step S238. Thus, the image list is displayed on the screen of the second audio and visual (AV) terminal 8 in step S239. Referring back to FIG. 18B, the example available AV image list has the button of “continuous viewing and listening” after step S239.

Referring to FIG. 20B, when the user selects the button of “continuous viewing and listening” in the image list, the Web browser unit 93 of the second audio and visual (AV) terminal 9 requests the menu server for network television 5 to send the metafile of the URL of the image content for network television 5 corresponding to the image content which is currently being viewed by the first audio and visual (AV) terminal 8 (mobile phone) in step S240.

In response to the request, the Web server unit 52 of the menu server for network televisions 5 sends the requested metafile to the Web browser unit 93 of the second audio and visual (AV) terminal 9 in step S241.

Referring to FIG. 20C, the image player unit 94 of the second audio and visual (AV) terminal 9 sends a request to deliver the image content designated by the metafile from the viewing position of the image content to the image delivery server for network television 4 in step S242.

In response to the request, the image delivery unit 42 of the image delivery server for network televisions 4 provides the requested image content with streaming delivery to the second audio and visual (AV) terminal 9 in step S243.

The image player unit 94 and the decode unit 95 of the second audio and visual (AV) terminal 9 extends the received and compressed image contents, and reproduces the extended contents in accordance with the sound volume, the audio channel, the caption and the like, which are received from the inheritance communication administrating server 10 in step S244.

Next, the image player unit 94 of the second audio and visual (AV) terminal 9 reports a reproduction state to the inheritance communication administrating server 10 to sequentially update the viewing position or the like in step S245. The content of the report from the image player unit 94 of the second audio and visual (AV) terminal 9 to the inheritance communication administrating server 10 includes the viewer ID, the AV terminal ID, the contents URL, the viewing position, the sound volume, the audio channel, the caption or the like.

In response to the report, the viewing and listening state administration unit 102 of the inheritance communication administrating server 10 registers the viewer ID, the contents URL, the viewing position, the sound volume, the audio channel, the caption or the like in the viewing and listening state administration data illustrated in FIG. 13 in step S246.

Thus, the image content can be viewed and listened to with the second audio and visual (AV) terminal 9 in step S247.

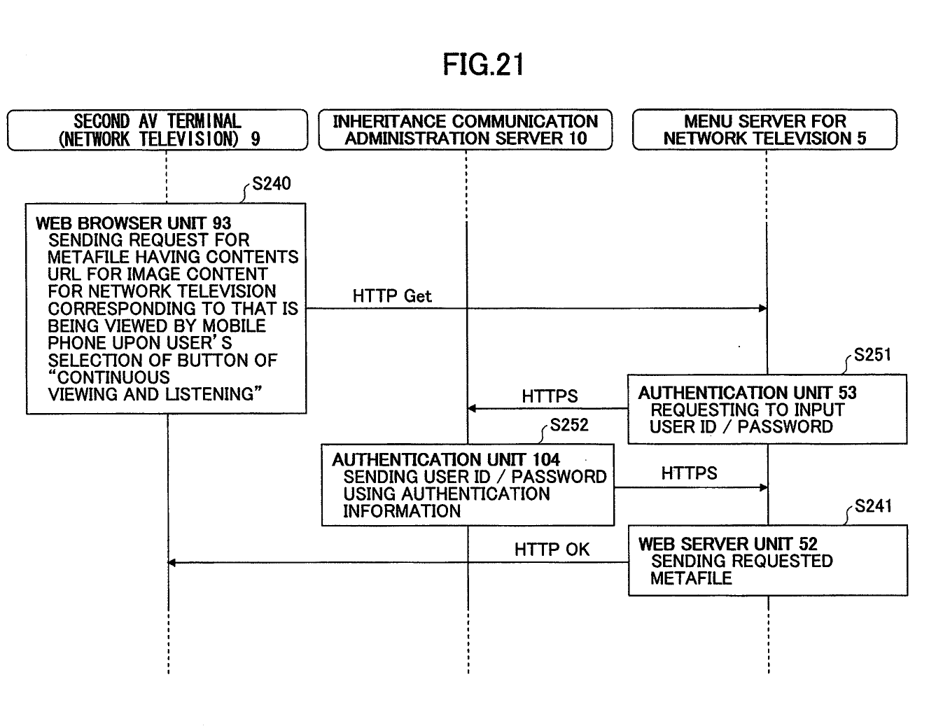

FIG. 21 is an example sequence diagram enabling a user to view and listen to an image with a network television which requires authorization in the example system structure illustrated in FIG. 10. Referring to FIG. 21, additional processes are inserted between steps S240 and S241 in FIG. 20B. The other steps S231 to S247 are similar to those in FIG. 20A to FIG. 20C.

Referring to FIG. 21, after the metafile is requested from the Web browser unit 93 of the second audio and visual (AV) terminal 9 in step S240, the authentication unit 53 of the menu server for network television 5 requests the inheritance communication administrating server 10 to input a user ID and a password in step S251.

In response to the request, the authentication unit 104 of the inheritance communication administrating server 10 uses the authentication information illustrated in FIG. 14 to send the user ID and the password to the authentication unit 53 of the menu server for network television 5 in step S252.

When the authentication is normally done, the Web server unit 52 of the menu server for network televisions 5 sends the requested metafile to the Web browser unit 93 of the second audio and visual (AV) terminal 9 in step S241.

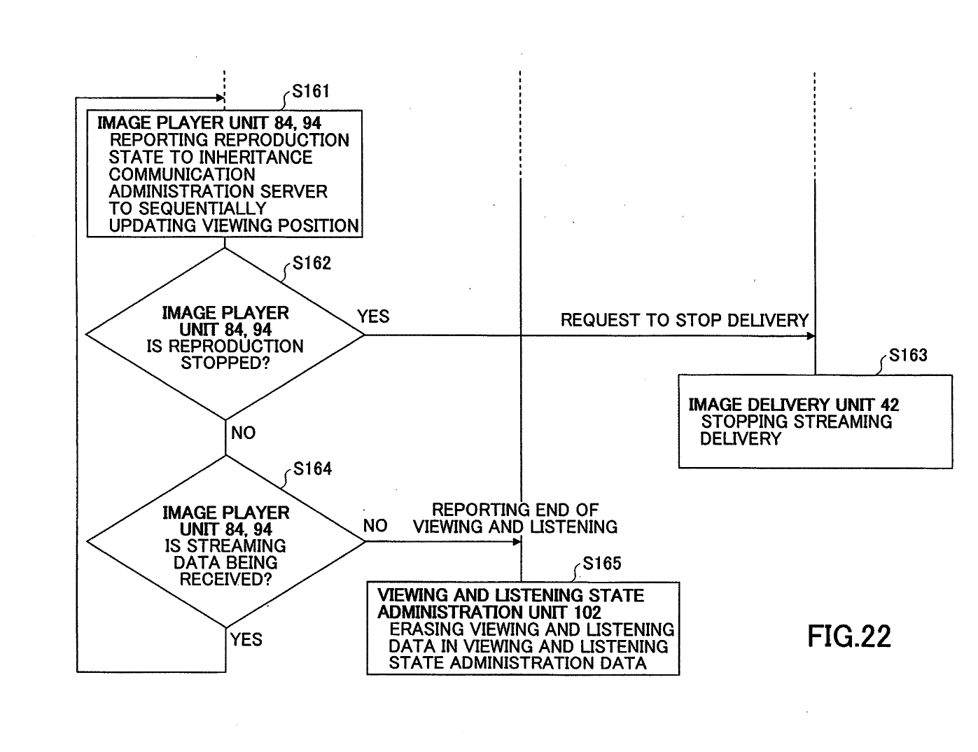

FIG. 22 is an example sequence diagram of ending viewing and listening in the AV terminal. The processes in FIG. 22 follow the processes in FIG. 16C and FIG. 20C, respectively.

Referring to FIG. 22, the image player units 84, 94 of the first audio and visual (AV) terminal 8 and the second audio and visual (AV) terminal 9 (AV terminals) report the reproduction states to the inheritance communication administrating server 10 to sequentially update the viewing positions in the inheritance communication administrating server 10 in step S161.

The image player units 84, 94 of the first audio and visual (AV) terminal 8 and the second audio and visual (AV) terminal 9 (AV terminals) determine whether the reproduction of the image contents is stopped in step S162.

When it is determined that the reproduction is stopped in YES of step S162, the first audio and visual (AV) terminal 8 and the second audio and visual (AV) terminal 9 (AV terminals) request the image delivery server for mobile phone 2 or the image delivery server for network television 4 (image delivery servers) to stop the delivery of the image contents. Then, the image delivery server for mobile phone 2 or the image delivery server for network television 4 (image delivery servers) stops the streaming delivery in step S163.

When it is determined that the reproduction is not stopped in NO of step S162, the image player units 84, 94 of the first audio and visual (AV) terminal 8 or the second audio and visual (AV) terminal 9 (AV terminals) determines whether the streaming data are being received in step S164.

When it is determined that the streaming data are being received in YES of step S164, the process returns to the report of the reproduction state in step S161.

When it is determined that the streaming data are not being received in NO of step S164, the first audio and visual (AV) terminal 8 and the second audio and visual (AV) terminal 9 (AV terminals) report to the inheritance communication administrating server 10 that viewing and listening to the image contents end. Then, the viewing and listening state administration unit 102 of the inheritance communication administrating server 10 erases corresponding data in the viewing and listening state administration data illustrated in FIG. 13 in step S165.

For example, in the disclosed inheritance communication administrating apparatus, user's operations for continuously viewing and listening to image contents, which are delivered from image delivery servers via a network such as the Internet, with different AV terminals may be simplified.

Further, it is possible to simplify user's operation in a situation where image contents, which are delivered from image delivery servers, are continuously viewed and listened to using different AV terminals.

Further, an appropriate administration can be realized since the viewing and listening state is administrated using the viewer ID and the AV terminal ID.

Further, the viewing and listening state administration data in the viewing and listening state administration unit 102 of the inheritance communication administrating server 10 include the fields of sound volume, audio channel, caption or the like as illustrated in FIG. 13. The viewing and listening state administration data are properly registered and regularly updated. Since the viewing and listening state administration data are used in starting reproduction in the other AV terminals, viewing and listening states desired by users may be inherited.

The number of the inheritance communication administrating servers 10 may be one or plural. Therefore, it is possible to realize decentralized administration of the viewing and listening information. For example, it is possible to configure a system such that predetermined IP addresses of a mobile phone provider and an Internet service provider (ISP) correspond to an inheritance communication administrating server 10 in common. In this case, tabulated IP address data (FIG. 15) of the inheritance communication administrating server 10 may be stored in the AV terminals 8, 9, and the AV terminals 8, 9 may send requests for the contents list directly to the inheritance communication administrating server 10 in the tabulated IP address data. When the viewing and listening information is registered, the viewing and listening information is sent to all inheritance communication administrating servers 10 listed in the tabulated IP address data. Then, after registering the viewing and listening information in all the inheritance communication administrating servers 10, continuous reproduction becomes possible.

Further, image contents most suitable for AV terminals can be delivered by allocating the AV terminals to the menu servers based on the terminal-menu server correspondence data illustrated in FIG. 12A.

Further, image contents most suitable for AV terminals can be delivered by allocating the AV terminals to the menu servers based on the terminal-menu server correspondence data illustrated in FIG. 12A.

Further, since the metafiles linked to a menu illustrated in FIG. 12C include server addresses information (image contents URL), the AV terminals may be allocated to the menu servers in charge of the AV terminals based on the terminal-menu server correspondence data illustrated in FIG. 12A. Thus, it becomes possible to designate the most suitable servers for the respective AV terminals.

Further, since the authentication information for the mobile phone providers and the Internet service providers (ISP) is stored in the inheritance communication administrating server 10, and the inheritance communication administrating server 10 carries out the authentication process for the menu servers, the burden on users in changing the AV terminals for continuously viewing and listening to the image contents can be reduced.

Further, since the current AV terminals may receive the image contents from viewing positions slightly earlier than the viewing positions in the previous AV terminals, which viewing positions are stored in the viewing and listening state administration data illustrated in FIG. 13, and are received from the inheritance communication administrating server 10, it is possible to avoid passing over in viewing and listening to the image contents when the users change from the previous AV terminals to current AV terminals.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An inheritance communication administrating apparatus comprising:
a state administration unit configured to receive a report in a certain timing from a first terminal apparatus, the report includes position data of a content received by the first terminal apparatus, and configured to store the position data; and
a list sending unit configured to receive a request for a list from a second terminal, acquire the requested list from a menu server, determine whether there is the content which is being viewed and listened to by a user of the second terminal in reference to the position data, and add to the list the content which is being viewed and listened to as a candidate content and send the list to the second terminal.

2. The inheritance communication administrating apparatus according to claim 1,
wherein an identifier of the user or an identifier of the first terminal is used for determining the content which is being viewed and listened to by the user.

3. The inheritance communication administrating apparatus according to claim 1,
wherein the position data further includes information of a sound volume, an audio channel, and a caption of the first terminal, and
the list sending unit is configured to report the information of the sound volume, the audio channel, and the caption of the first terminal to the second terminal.

4. The inheritance communication administrating apparatus according to claim 1,
wherein the inheritance communication administrating apparatus communicates with another inheritance communication administrating apparatus having a function the same as a function of the inheritance communication administrating apparatus, and the inheritance communication administrating apparatus sends the position data to or receives the position data from the other inheritance communication administrating apparatus for achieving a decentralized administration of the position data.

5. The inheritance communication administrating apparatus according to claim 1,
wherein the content has plural modes of screen sizes, frame rates, a number of colors, compression methods and delivery bands in conformity with performances of the first and second terminal, and the list to be sent to the second terminal is automatically determined in conformity with the performance of the second terminal.

6. The inheritance communication administrating apparatus according to claim 1, further comprising:
one or more content delivery servers configured to store the same contents and deliver a requested content via a network,
wherein the suitable image delivery server for the first or second terminal is selected from the content delivery servers based on network paths of the first or second terminal to the content delivery servers and congestion of the network paths.

7. The inheritance communication administrating apparatus according to claim 1,
wherein login information for authentication in accessing the menu server on behalf of the second terminal is stored in the inheritance communication administrating apparatus.

8. The inheritance communication administrating apparatus according to claim 1,
wherein the list sending unit sends another viewing position, which is a predetermined time earlier than a viewing position indicated by the position data, to the second terminal.

9. A control method of an inheritance communication administration in a content delivery system, the control method comprising:
receiving a report which includes position data of a content received by a first terminal in a certain timing from the first terminal apparatus;
storing the position data;
receiving a request for a list from a second terminal;
acquiring the requested list from a menu server;
determining whether there is the content which is being viewed and listened to by a user of the second terminal in reference to the position data;
adding to the list the content which is being viewed and listened to as a candidate content; and
sending the list to the second terminal.

10. The control method according to claim 9,
wherein the determining whether there is the content which is being viewed and listened to by the user makes use of an identifier of the user or an identifier of the first terminal.

11. The control method according to claim 9,
wherein, in the receiving the report, the position data further include information of a sound volume, an audio channel, and a caption of the first terminal, and
the sending the list further includes reporting the information of the sound volume, the audio channel, and the caption of the first terminal to the second terminal.

12. The control method according to claim 9, further comprising:
communicating between the inheritance communication administrating apparatus and another inheritance communication administrating apparatus having a function the same as a function of the inheritance communication administrating apparatus to send and receive the position data for achieving a decentralized administration of the position data.

13. The control method according to claim 9, further comprising:
allocating the content having plural modes of screen sizes, frame rates, a number of colors, compression methods and delivery bands to the first or second terminal in conformity with performances of the first or second terminal.

14. The control method according to claim 9, further comprising:
selecting a suitable content for the first or second terminal out of plural image contents on the basis of network paths of the first or second terminal to servers in which the contents are stored, and congestion of the network paths.

15. The control method according to claim 9, further comprising:
reporting another viewing position, which is a predetermined time earlier than a viewing position indicated by the position data, to the second terminal.
